(19) United States
(12) Patent Application Publication
(10) Pub. No.: US 2008/0042952 A1
(43) Pub. Date: Feb. 21, 2008

(54) Power supply circuit of liquid crystal display for reducing residual image

(75) Inventor: Zhan-Wei Fu, Shenzhen (CN)

Correspondence Address: WEI TE CHUNG;FOXCONN INTERNATIONAL, INC., 1650 MEMOREX DRIVE, SANTA CLARA, CA, 95050, US

(73) Assignees: INNOCOM TECHNOLOGY (SHENZHEN) CO., LTD.; INNOLUX DISPLAY CORP.

(21) Appl. No.: 11/894,113

(22) Filed: Aug. 20, 2007

(30) Foreign Application Priority Data
Aug. 18, 2006 (TW) 95130448

(51) Int. Cl. G09G 3/36

(52) U.S. Cl. 345/87

(57) ABSTRACT

An exemplary power supply circuit (212) for a liquid crystal display (LCD) (2) includes a power source integrated circuit (IC) (214). The power source IC includes a voltage input (213) configured for receiving an external power source V_{cc}; a positive voltage output (215) configured for providing a first voltage; a negative voltage output (216) configured for providing a second voltage; a detecting circuit (2141) configured for generating a control signal when the LCD is turned off; and a switching circuit (2142) configured for receiving the control signal and electrically connecting the negative voltage output to the positive voltage output in order to increase a potential of the negative voltage output quickly.

### FIELD OF THE INVENTION

The present invention relates to power supply circuits used in liquid crystal displays (LCDs), and particularly to a power supply circuit which can reduce or eliminate residual images of an LCD.

### GENERAL BACKGROUND

A typical LCD has the advantages of portability, low power consumption, and low radiation. LCDs have been widely used in various portable information products, such as notebooks, personal digital assistants (PDAs), video cameras and the like. Furthermore, the LCD is considered by many to have the potential to completely replace CRT (cathode ray tube) monitors and televisions.

A conventional LCD includes a liquid crystal display module (LCM), and a control board configured to provide image signals to the LCM. The control board includes at least one power supply circuit configured to provide operation voltages to the LCM. The operation voltages generally include a positive voltage and a negative voltage. The LCM includes a plurality of display units arranged in a matrix. Each display unit is driven by a switching unit such as a thin film transistor, which is controlled by the positive voltage and the negative voltage.

FIG. 6 is a diagram of a typical power supply circuit of an LCD. The LCD includes an LCM (not shown) as well as the power supply circuit. The LCM includes a plurality of display units. The power supply circuit 112 includes a power source integrated circuit (IC) 1120, a first capacitor 1124, and a second capacitor 1125. The power source IC 1120 includes a voltage input 1121 configured to receive an external power source V_{cc}, a first voltage output 1122 configured to provide a positive voltage such as +5.5V, +3.3V, or a gate switch on voltage (“VGH”, not shown) to the LCM, and a second voltage output 1123 configured to provide a negative voltage such as a gate switch off voltage (“VGL”, not shown) to the LCM. The first capacitor 1124 is connected between the first voltage output 1122 and ground so as to stabilize the positive voltage. The second capacitor 1125 is connected between the second voltage output 1123 and ground so as to stabilize the negative voltage.

The first and second capacitors 1124, 1125 respectively connected to the first voltage output 1122 and the second voltage output 1123 are capable of storing electric charge. Thus when the LCD is turned off, the negative voltage such as the gate switch off voltage VGL provided from the second voltage output 1123 to the LCM cannot be discharged to a zero voltage because of the characteristic of the second capacitor 1125. Therefore, electric charge stored in each display unit of the LCM is not discharged quickly via the corresponding thin film transistor which is controlled by the negative voltage. Thereby, a so-called residual image may be produced on a display screen of the LCM.

It is desired to provide a power supply circuit and an LCD which can overcome the above-described deficiencies.

### SUMMARY

In one preferred embodiment, a power supply circuit for an LCD includes a power source integrated circuit (IC). The power source IC includes a voltage input configured for receiving an external power source; a positive voltage output configured for providing a first voltage; a negative voltage output configured for providing a second voltage; a detecting circuit configured for generating a control signal when the LCD is turned off; and a switching circuit configured for receiving the control signal and electrically connecting the negative voltage output to the positive voltage output in order to increase a potential of the negative voltage output quickly.

Other novel features and advantages will become more apparent from the following detailed description when taken in conjunction with the accompanying drawings.

### BRIEF DESCRIPTION OF THE DRAWINGS

FIG. 1 is a block diagram of an LCD according to a first embodiment of the present invention, the LCD including a power supply circuit.

FIG. 2 is a diagram of the power supply circuit of FIG. 1, the power supply circuit including a detecting circuit and a switching circuit.

FIG. 3 is a diagram of the detecting circuit of FIG. 2.

FIG. 4 is a diagram of the switching circuit of FIG. 2.

FIG. 5 is a diagram of a power supply circuit of an LCD according to a second embodiment of the present invention.

FIG. 6 is a diagram of a conventional power supply circuit of an LCD.

### DETAILED DESCRIPTION OF PREFERRED EMBODIMENTS

Reference will now be made to the drawings to describe various embodiments of the present invention in detail.

FIG. 1 is a block diagram of an LCD 2 according to a first embodiment of the present invention. The LCD 2 includes a control board 21 and an LCM 22. The LCM 22 includes a plurality of display units (not shown) arranged in a matrix for displaying images. The control board 21 includes a signal processing circuit 211 and a power supply circuit 212. The signal processing circuit 211 is configured to provide a plurality of control signals and a plurality of image signals to the LCM 22. The power supply circuit 212 is configured to provide a plurality of positive voltages and a plurality of negative voltages to the LCM 22.

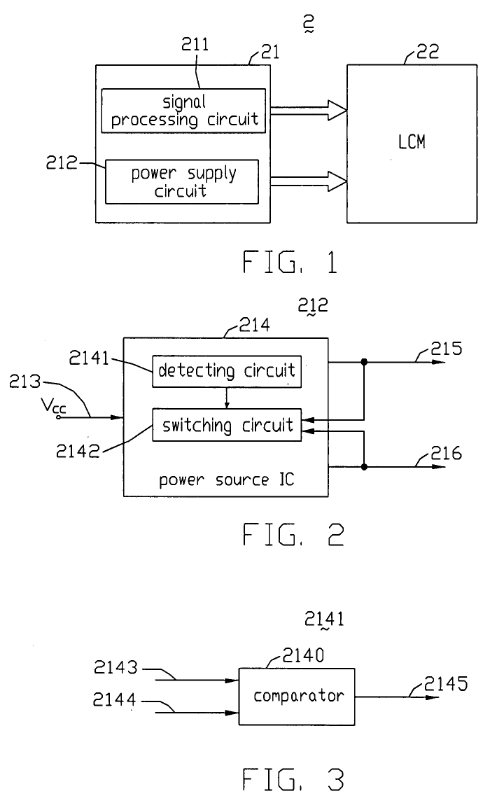

Referring also to FIG. 2, this is a diagram of the power supply circuit 212. The power supply circuit 212 includes a power source IC 214. The power source IC 214 includes a detecting circuit 2141 and a switching circuit 2142 integrated therein. The power source IC 214 further includes a voltage input 213 configured to receive an external power source V_{cc}, a positive voltage output 215 configured to provide a positive voltage such as +5.5V, +3.3V or a gate switch on voltage (“VGH”, not shown) to the LCM 22, and a negative voltage output 216 configured to provide a negative voltage such as a gate switch off voltage (“VGL”, not shown) to the LCM 22.

Referring also to FIG. 3, this is a diagram of the detecting circuit 2141. The detecting circuit 2141 includes a comparator 2140. The comparator 2140 includes a first input 2143, a second input 2144, and an output 2145. The first input 2143 of the comparator 2140 is configured to receive the external power source V_{cc}. The second input 2144 of the comparator 2140 is configured to receive a reference voltage, which is equal to a normal output voltage of the external power source V_{cc}. The output 2145 of the comparator 2140 is configured to generate control signals according to a result of the comparison of the external power source V_{cc} and the reference voltage, and provide the control signals to the switching circuit 2142 for switching on or switching off the switching circuit 2142.

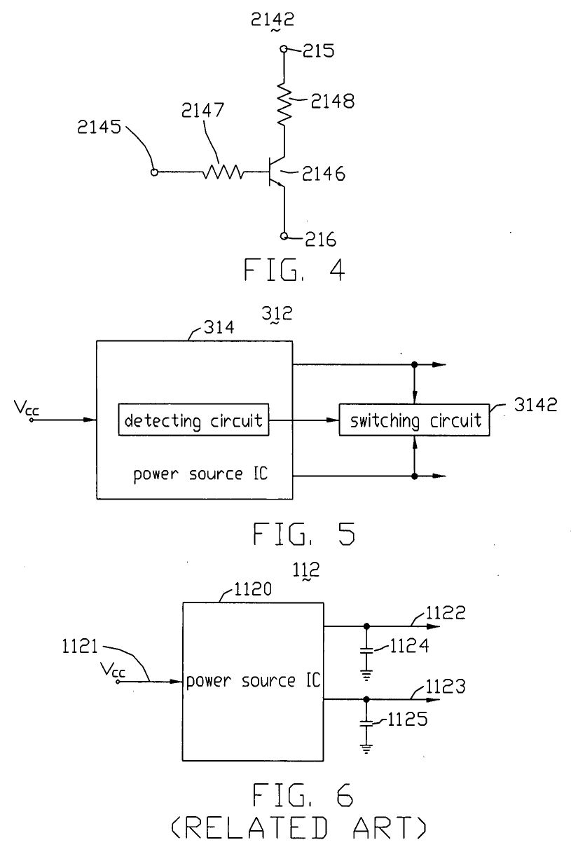

Referring also to FIG. 4, this is a diagram of the switching circuit 2142. The switching circuit 2142 includes a negative-positive-negative (NPN) bipolar transistor 2146, a current limiting resistor 2147, and a bias resistor 2148. The NPN bipolar transistor 2146 includes a collector electrode connected to the positive voltage output 215 of the power source IC 214 via the bias resistor 2148, an emitter electrode connected to the negative voltage output 216 of the power source IC 214, and a base electrode connected to the output 2145 of the comparator 2140 via the current limiting resistor 2147 for receiving the control signals.

When the LCD works normally, the comparator 2140 generates a first control signal when the external power source V_{cc} is equal to the reference voltage. Then the first control signal is provided by the output 2145 of the comparator 2140 to the base electrode of the NPN bipolar transistor 2146 via the current limiting resistor 2147, and the NPN bipolar transistor 2146 is switched off.

When the LCD is turned off, the comparator 2140 generates a second control signal when the external power source V_{cc} is decreased and is less than the reference voltage. Then the second control signal is provided by the output 2145 of the comparator 2140 to the base electrode of the NPN bipolar transistor 2146 via the current limiting resistor 2147, and the NPN bipolar transistor 2146 is switched on. Thus the positive voltage output 215 of the power source IC 214 is connected to the negative voltage output 216 of the power source IC 214 via the bias resistor 2148 and the activated NPN bipolar transistor 2146 in series. Therefore a voltage of the negative voltage output 216 of the power source IC 214 can be charged to zero voltage by the positive voltage output 215 of the power source IC 214. Thus, electric charge stored in each display unit of the LCM 22 is discharged quickly via the corresponding thin film transistor which is turned on when the voltage of the negative voltage output 216 is approximately equal to zero. Thereby, any residual image produced on a display screen of the LCM 22 may be depressed or even eliminated.

In summary, the LCD 2 includes the detecting circuit 2141 configured to generate a second control signal when the LCD 2 is turned off, and the switch circuit 2142 configured to receive the second control signal and electrically connect the negative voltage output 216 to the positive voltage output 215 in order to quickly increase a potential of the negative voltage output 216. Therefore electric charge stored in each display unit of the LCM 22 is quickly discharged, and any residual image that would otherwise be produced on the LCM 22 can be mitigated or even eliminated.

In an alternative embodiment, the NPN bipolar transistor 2146 may also be replaced by an n-channel metal-oxide-semiconductor field-effect transistor (NMOSFET).

FIG. 5 is a diagram of a power supply circuit 312 of an LCD according to a second embodiment of the present invention. The power supply circuit 312 is similar to the power supply circuit 212 of the LCD 2 of the first embodiment. However, a switching circuit 3142 of the power supply circuit 312 is arranged outside a power source IC 314, at a periphery of the power source IC 314.

It is to be understood, however, that even though numerous characteristics and advantages of preferred and exemplary embodiments have been set out in the foregoing description, together with details of the structures and functions of the embodiments, the disclosure is illustrative only; and that changes may be made in detail, especially in matters of arrangement of parts within the principles of present invention to the full extent indicated by the broad general meaning of the terms in which the appended claims are expressed.

What is claimed is:

1. A power supply circuit for a liquid crystal display (LCD), the power supply circuit comprising:
a power source integrated circuit (IC), the power source IC comprising:
a voltage input configured for receiving an external power source;
a positive voltage output configured for providing a first voltage;
a negative voltage output configured for providing a second voltage;
a detecting circuit configured for generating a control signal when the LCD is turned off; and
a switching circuit configured for receiving the control signal and electrically connecting the negative voltage output to the positive voltage output in order to increase a potential of the negative voltage output.

2. The power supply circuit as claimed in claim 1, wherein the power source IC is configured for transforming the external power source to the first and second voltages, the first voltage being a positive voltage, the second voltage being a negative voltage.

3. The power supply circuit as claimed in claim 1, wherein the detecting circuit and the switching circuit are integrated in the power source IC.

4. The power supply circuit as claimed in claim 1, wherein the detecting circuit is integrated in the power source IC, and the switching circuit is arranged outside of the power source IC.

5. The power supply circuit as claimed in claim 1, wherein the detecting circuit comprises a comparator, the comparator comprises:
a first input configured for receiving an external power source;
a second input configured for receiving a reference voltage; and
an output; and
the comparator is configured for comparing the external power source and the reference voltage, and generating a first control signal to switch on the switching circuit or a second control signal to switch off the switching circuit according to a result of the comparison.

6. The power supply circuit as claimed in claim 5, wherein the first control signal is generated when the external power source is approximately equal to the reference voltage.

7. The power supply circuit as claimed in claim 5, wherein the second control signal is generated when the external power source is less than the reference voltage.

8. The power supply circuit as claimed in claim 5, wherein the switching circuit comprises a transistor, a current limiting resistor, and a bias resistor, and the transistor comprises:
a collector electrode connected to the positive voltage output of the power source IC via the bias resistor;
an emitter electrode connected to the negative voltage output of the power source IC; and
a base electrode connected to the output of the comparator via the current limiting resistor for receiving the first and the second control signals.

9. The power supply circuit as claimed in claim 8, wherein the transistor is a negative-positive-negative bipolar transistor.

10. The power supply circuit as claimed in claim 8, wherein the transistor is an n-channel metal-oxide-semiconductor field-effect transistor.

11. A liquid crystal display (LCD) comprising:
a liquid crystal module (LCM) comprising a plurality of display units; and
a control board configured for providing operation voltages to the LCM, the control board comprising a power source integrated circuit (IC), the power source IC comprising:
a voltage input configured for receiving an external power source;
a positive voltage output configured for providing a first voltage;
a negative voltage output configured for providing a second voltage;
a detecting circuit configured for generating a control signal when the LCD is turned off; and
a switching circuit configured for receiving the control signal and electrically connecting the negative voltage output to the positive voltage output in order to increase a potential of the negative voltage output.

12. The LCD as claimed in claim 11, wherein the power source IC is configured for transforming the external power source to the first and second voltages, the first voltage being a positive voltage, the second voltage being a negative voltage.

13. The LCD as claimed in claim 11, wherein the detecting circuit and the switching circuit are integrated in the power source IC.

14. The LCD as claimed in claim 11, wherein the detecting circuit is integrated in the power source IC, and the switching circuit is arranged outside of the power source IC.

15. The LCD as claimed in claim 11, wherein the detecting circuit comprises a comparator, the comparator comprises:
a first input configured for receiving an external power source;
a second input configured for receiving a reference voltage; and
an output; and
the comparator is configured for comparing the external power source and the reference voltage, and generating a first control signal to switch on the switching circuit or a second control signal to switch off the switching circuit according to a result of the comparison.

16. The LCD as claimed in claim 15, wherein the first control signal is generated when the external power source is approximately equal to the reference voltage.

17. The LCD as claimed in claim 15, wherein the second control signal is generated when the external power source is less than the reference voltage.

18. The LCD as claimed in claim 15, wherein the switching circuit comprises a transistor, a current limiting resistor, and a bias resistor, and the transistor comprises:
a collector electrode connected to the positive voltage output of the power source IC via the bias resistor;
an emitter electrode connected to the negative voltage output of the power source IC; and
a base electrode connected to the output of the comparator via the current limiting resistor for receiving the first and the second control signals.

19. The LCD as claimed in claim 18, wherein the transistor is a negative-positive-negative bipolar transistor.

20. The LCD as claimed in claim 18, wherein the transistor is an n-channel metal-oxide-semiconductor field-effect transistor.
